(19) United States
(12) Patent Application Publication
(10) Pub. No.: US 2004/0107276 A1
(43) Pub. Date: Jun. 3, 2004

(54) Network interface management system and method thereof

(76) Inventor: Kee Jin Mo, Seoul (KR)

Correspondence Address: Richard C. Litman, LITMAN LAW OFFICES, LTD., P.O. Box 15035, Arlington, VA, 22215, US

(21) Appl. No.: 10/607,257

(22) Filed: Jun. 27, 2003

(30) Foreign Application Priority Data
Nov. 28, 2002 (KR) 74933/2002

(51) Int. Cl. G06F 15/173

(52) U.S. Cl. 709/223

(57) ABSTRACT

The present invention relates to a network interface management system and method thereof, for granting a unique code corresponding to an object, for example an internet site, interfaced with each piece of network equipment within each network equipment system to interface information and for changing interface status information of each piece of network equipment automatically using the granted code, if there are changes of interface information of a predetermined piece of network equipment. The present invention comprises a network equipment system having information that can identify a site connected to one or more interfaces of each piece of network equipment and including one or more management information bases that store the interface information; and a network management system for polling the management information bases of each piece of the network equipment within the network equipment system to collect the interface information, adopting information that can identify each site as primary information to compare the primary information with already registered information and correcting the interface information for each piece of the network equipment.

### BACKGROUND OF THE INVENTION

1. Field of the Invention

The present invention relates to a network interface management system and method thereof, for granting a unique code corresponding to a target, for example an internet site, interfaced with each piece of network equipment within each network equipment system to interface information and for changing interface status information of each piece of network equipment automatically using the granted code, if there are changes of interface information of a predetermined piece of network equipment.

2. Background of the Related Art

Conventional pieces of computer network equipment are interfaced and fixed in hardware so that any one of them cannot be taken out or moved.

Simple Network Management Protocol (SNMP) is for managing network equipment remotely and manages desired ports using object indexes granted to each port by themselves in order to distinguish each port of the network equipment remotely.

Network management is based on giving and taking predetermined information between a manager and an agent. Predetermined information or a resource to be managed is called an object and a collected body of the objects is called a Management Information Base (MIB).

A Network Management System (NMS) grasps a configuration of pieces of network equipment and their statuses using the SNMP.

Each piece of network equipment supporting the SNMP has the MIB, a kind of database that exhibits the status of each piece of network equipment, so that the network management system may read the status information, supervise the status of each piece of network equipment and change settings of them.

Therefore, the network management means that the network management system obtains predetermined values from MIBs provided by each piece of network equipment, namely management targets including a workstation, a printer, a file server, a hub, a router or a switching means. Then, the network management system grasps a status of the corresponding network equipment or changes the obtained values.

FIG. 1 illustrates a configuration of a conventional network interface management system.

Referring to FIG. 1, the conventional network interface management system comprises a network equipment system 110, a network management system 120 for managing status of the network equipment system 110 and a user interface 130.

The network equipment system 110 comprises pieces of network equipment 111, 113 and 115 and MIBs 112, 114 and 116 that store information and statuses of resources to be managed between a manager and an agent.

The network management system 120 comprises polling agents 121, 122 and 123 that polls the MIBs 112, 114 and 116 to read status information of each piece of network equipment 111, 113 and 115 and a database server 125 that updates status information into the one read from the polling agents 121, 122 and 123 and stores the same.

The user interface 130 requests a status of each piece of the network equipment 111, 113 and 115 to the database server 125 and provides the result to a user.

The conventional network interface management system will be described below with reference to FIG. 1.

The network management system (NMS) 120 grasps a configuration and status of the network equipment system 110 using the SNMP.

Pieces of the network equipment ill, 113 and 115, supporting the SNMP, comprise each MIB 112, 114 and 116, a kind of database for indicating a status of pieces of the network equipment 111, 113 and 115. They read information from the MIBs 112, 114 and 116 to supervise the statuses of themselves. If pieces of the network equipment 111, 113 and 115 support SNMP, MIB I, MIB II, the network management system 120 can manage pieces of the network equipment 111, 113 and 115.

Each piece of the network equipment 111, 113 and 115 in the network equipment system 110 exhibits granted port names of itself or granted names of sites connected to itself externally for a user, and collects information internally by using object indexes of pieces of the network equipment 111, 113 and 115.

More specifically, each piece of the network equipment 111, 113 and 115 comprises a plurality of modules M1 through M9 where each module has the predetermined number of ports and each port is connected to a predetermined site.

Each MIB 112, 114 and 116 is registered host names for identifying each piece of the network equipment 111, 113 and 115, module/port numbers, indexes and a plurality of line speed, etc., and stores the registered interface information for itself.

Hereinafter, the network equipment is abbreviated to equipment.

The interface information is also registered to the database server 125 of the network management system 120 for one-to-one management.

After registration, each piece of the equipment 111, 113 and 115 stores interface information on itself according to a utilization status and operation status of predetermined targets connected to the interfaces of the MIBs 112, 114 and 116.

The polling agents 121, 122 and 123 poll the MIBs 112, 114 and 116 to collect the interface information and store the collected interface information to the database server 125.

The database server 125 stores the collected interface information separately for each piece of the equipment/each interface and performs network management such as fault management or performance management for each port by comparing the registered interface information with the collected one for each piece of the equipment.

The network management system 120 finds the same index among the collected information with a unique one that each port of the equipment has, and updates the interface information registered in the database server 125 with the collected one of the found index.

If a piece of equipment needing management is newly registered, site names, namely, port names and object indexes are matched one-to-one to be registered.

When a user queries a predetermined key value, the user interface 130 gets corresponding interface information from the database server 125 and displays the same on a graphic user interface screen.

Each piece of the equipment 111, 113 and 115 allows module or port changes. Accordingly, the indexes are reallocated orderly when a module is added or replaced with the other one, or in case of add/change of a port.

Then, the network management system 120 reads the interface information for each piece of the equipment 111, 113 and 115 from the MIBs 112, 114 and 116 and then stores the same. Then, an index value connected to a predetermined target can be changed manually through the user interface 130.

Referring to FIG. 2, a predetermined site, for example ABC company New Jersey branch office, is connected to a predetermined port, whose index is 6, of the network equipment A 150. Now the network management system 160 queries current line utility of ABC company New Jersey branch office to the network equipment A 150. Then the network equipment A 150 gives the utility corresponding to the index 6 and stored in the MIB back.

As the forgoing, the interface information was managed by using a predetermined key, namely an index for network management in the conventional art. If modules and ports are added/changed/dropped in a piece of equipment, the index for each port is reallocated. Consequently, there is a problem that the indexes should be changed again according to a predetermined target.

FIGS. 3 and 4 illustrate indexes before and after the modules and ports of the equipment A are changed.

When 4 modules are mounted on the equipment A and 8 ports are existed on each module, the indexes are allocated sequentially from a port of a first module in use. No index is allocated to a port of no use.

Before the equipment change, ABC company New Jersey branch office is connected to an index 10 of module B and EFG company LA branch office is connected to an index 3 of module A. The equipment change is accomplished as described below. The module A is removed. The module B is replaced with one as shown. Index positions are changed in the module C and D according to port adds/drops. Each line speed of the interfaces connected to the two sites is also changed.

Before the equipment change, information of ABC company New Jersey branch office is registered to the network management system to be read at index 10 of the equipment A. Thus line status of ABC company New Jersey branch office is read with reference to the index 10 of the equipment A.

After the equipment change, each allocated index is changed due to index reallocation. That is, ABC company New Jersey branch office is connected to an index 3 of the module C and EFG company LA branch office is connected to an index 10 of the module D.

If the changed information is not updated, the network management system reads the index 10 of the module A in order to read a network status of the registered ABC company New Jersey branch office. Consequently, the result is about the network status of EFG company LA branch office, which is very different from the desired one.

To solve this problem, the conventional network management system probes the changed indexes and updates them one by one manually. That is, in order to read the network status of ABC company New Jersey branch office, the user should change the index of the corresponding site registered to the network management system into 3 from the index 10.

FIG. 5 shows an example of management by using the key in the conventional network management system.

If modules and ports of each piece of equipment are changed, the network management system calls for interface information of each piece of the equipment as predetermined key values and receives the one of serial modules/ports or Ethernet modules/ports, etc., corresponding the key values from each MIB.

If the user requests predetermined key values via the user interface, at this time, the network management system provides the user interface information corresponding to the key values but entirely different one.

The user, receiving the interface information, corrects the index values of the interface information connected to a predetermined site manually through the user interface.

When module adds/replacements or port adds/changes are occurred in a piece of equipment, heavy operation is loaded in a process of investigating and correcting indexes. Also, accuracy of the collected data becomes lowered until the correction is completed.

In an aspect of the SNMP limit and in the conventional network management system, when entire or a part of pieces of equipment are troubled to be replaced or network lines connected to a portion of ports of the equipment are moved to the other equipment, statistics collected by the network management system or every document on a line status that is necessary for policy establishment can be lost. Additionally, document continuity before and after the line moves can also be disconnected.

Networks of large scale ISPs or companies undertake various changes such as change, new establishment, cancel, etc., so that there are hundreds of port index changes.

Therefore, the network management becomes a large problem after development of a piece of flexible equipment because data accuracy becomes lowered and the index changes should be corrected manually in time of the interface adds/drops/changes.

### SUMMARY OF THE INVENTION

An object of the invention is to solve at least the above problems and/or disadvantages and to provide at least the advantages described hereinafter.

Accordingly, one object of the present invention is to solve the foregoing problems by providing a network interface automatic management system for granting one or more unique codes to a predetermined site interfaced with each piece of network equipment to collect and manage the interface information of each piece of the equipment based on the granted codes.

Another object of the present invention to provide a network interface automatic management system for distinguishing interface information of each piece of equipment based on the granted codes, which is a combination of formalized regulation with multi-step sub-codes in order to distinguish predetermined sites by use of the codes.

Another object of the invention to provide a network interface automatic management system for reading all of the interface information of pieces of target equipment by adopting a code granted to a predetermined site as a primary key.

The foregoing and other objects and advantages are realized by providing an apparatus for managing network interface information, comprising: a network equipment system having information that can identify a site connected to one or more interfaces of each piece of network equipment and including one or more management information bases that store the interface information; and a network management system for polling the management information bases of each piece of the network equipment within the network equipment system to collect the interface information, adopting information that can identify each site as primary information to compare the primary information with already registered information and correcting the interface information for each piece of the network equipment

According to another aspect of the invention, an apparatus for managing network interface information automatically, comprises: polling agents for polling interface information of each piece of network equipment from management information bases of each piece of the network equipment at every predetermined time or in real-time; an automatic management module for confirming changes or adds of the interface information read from the polling agents, correcting or managing the interface information; and a database server for storing registration information for each piece of the network equipment or each interface managed by the automatic management module and providing user interface with the stored information

According to another aspect of the invention, the automatic management module comprises: a management target equipment list portion for managing interface changes; a site code management portion for enabling information matched with each code to be inputted and displayed; an automatic management engine for collecting information of each piece of the network equipment at every predetermined time or in real-time using the management target list and comparing the collected information with the registration information to manage network interface information automatically; and an interface management display portion for displaying a log of corrected information and intervention by an administrator, if necessary, as a web page.

According to another aspect of the invention, a method for managing network interface information, comprises steps of: (a) granting codes, indicating sites connected to each interface of each piece of network equipment and generating a management target equipment list; (b) collecting interface information for each piece of the network equipment through Simple Network Management Protocol to generate a table at every predetermined time or in real-time; (c) checking non-defectiveness of the codes for the collected interface information of the table; and (d) comparing information registered to a network management system with the collected table using the granted codes and correcting changes of the registered information.

According to another aspect of the invention, the automatic management for the network equipment comprises the sub-steps of: collecting information from each piece of the automatic management target equipment selected by an administrator to generate the table; notifying abnormal codes among the collected information to the administrator, deleting the abnormal codes from the collected table, checking operation statuses of an interface of each piece of the network equipment to decide if the codes are necessary and notifying the checked results to the administrator; comparing the collected table with the registered information and correcting the registered information; and deciding if a line is canceled or used and deleting unregistered codes from a site code list.

According to another aspect of the invention, a method for managing network interface information, comprises the steps of: (a) inputting interface information connected or to be connected to an interface of each piece of network equipment; (b) matching the interface information with interface description; (c) registering the inputted information to a network management system; and (d) changing the interface information using codes of the inputted or registered information.

According to another aspect of the invention, a method for managing network interface information, comprises the steps of: (a) inputting a hostname to each piece of network equipment; (b) inputting interface information including a code of corresponding site to one or more interfaces of each piece of the network equipment; (c) generating an automatic management list to register the list to a network management system; (d) receiving current network equipment information at a predetermined period or in real-time, comparing the received information with the one registered to the network management system using one or more hostname and code information, and performing at lest one of a group of change of the interface information, addition of a new interface and deletion; and (e) displaying a new interface management picture.

According to the present invention, by granting a unique code for identifying a predetermined site connected to an interface of each piece of network equipment to an interface description and performing network management on the basis of the granted code, data accuracy is always guaranteed without correction of registration information of the network management system.

Additionally, registration procedure of the network management system for interface adds, drops or changes of each piece of network equipment become simple.

When moving a line to the other network equipment, the existed data is not lost. Therefore, data continuity can be maintained and operational manpower for high quality management also can be reduced.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 illustrates a configuration for a conventional network interface management system;

FIG. 2 illustrates an example of the conventional network interface management;

FIG. 3 illustrates an example of managing interface information before/after a network equipment change;

FIG. 4 illustrates changed network interface information of FIG. 3;

FIG. 5 illustrates a conceptual diagram for the conventional network management;

FIG. 6 illustrates an network interface automatic management system according to an embodiment of the present invention;

FIG. 7 illustrates a conceptual diagram of the network interface automatic management according to an embodiment of the present invention;

FIG. 8 illustrates a status that a code is granted to each piece of the network equipment;

FIG. 9 illustrates a table of interface information for each piece of network equipment;

FIG. 10 illustrates a status of code abnormality check according to the present invention;

FIG. 11 illustrates automatically changed network interface information by the network management system according to the present invention;

FIG. 12 illustrates a diagram for automatic management before/after the network interface information change according to an embodiment of the present invention;

FIG. 13 illustrates a changed status of the interface information according to FIG. 12;

FIG. 14 illustrates a list of pieces of automatic management target network equipment;

FIG. 15 illustrates a status of site code management according to the present invention;

FIG. 16 illustrates a management status of an automatic management engine;

FIG. 17 illustrates an automatic interface management display;

FIG. 18 illustrates a status for notifying a log generation to the administrator;

FIG. 19 is a flow chart for network interface automatic management method according to an embodiment of the present invention;

FIG. 20 is a flow chart of an automatic management engine according to the present invention.

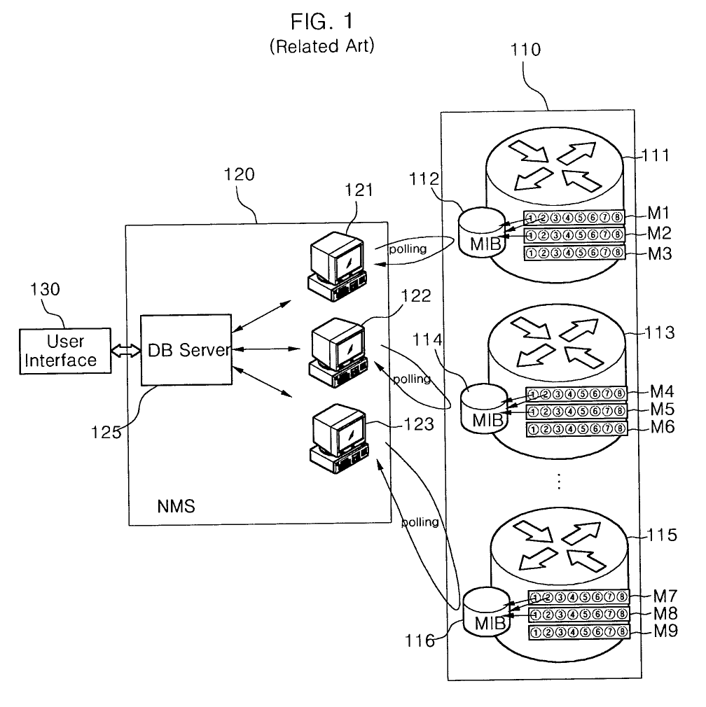

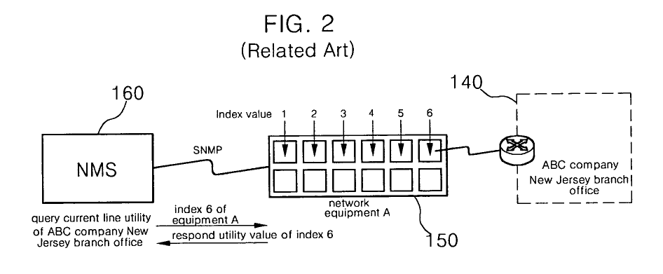

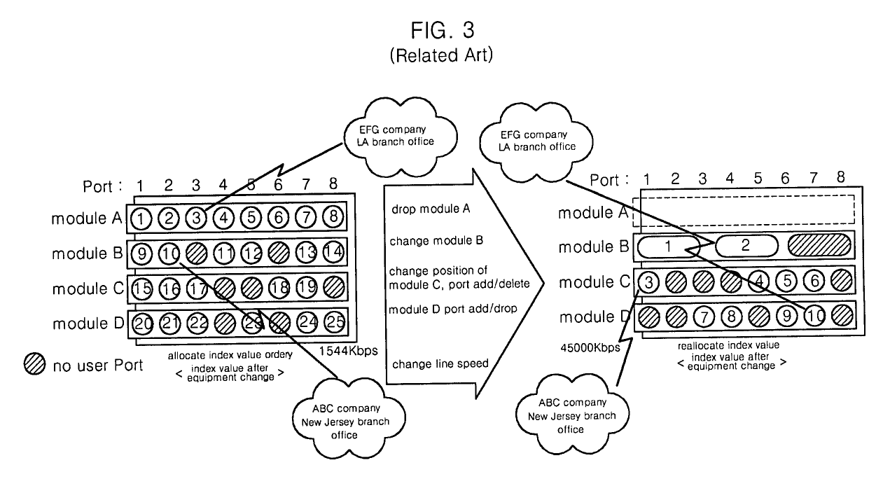

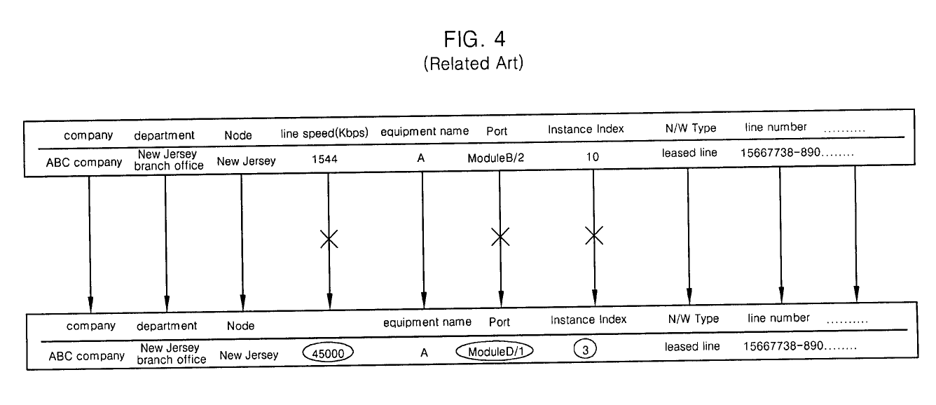

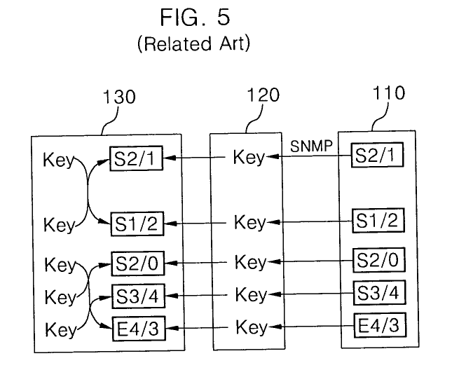

### DETAILED DESCRIPTION OF PREFERRED EMBODIMENTS

The following detailed description will present a network interface management system and method thereof according to a preferred embodiment of the invention in reference to the accompanying drawings.

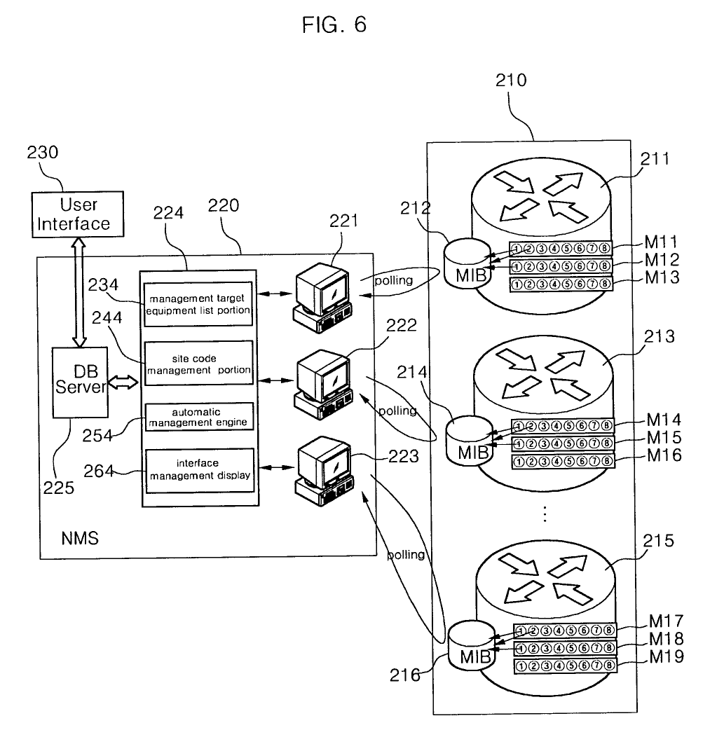

FIG. 6 illustrates a configuration of a automatic management system of network interface according to an embodiment of the present invention.

Referring FIG. 6, the automatic management system of network interface comprises a network equipment system 210, a network management system 220 and a user interface 230.

The network equipment system 210 includes MIBs 212, 214 and 216 to which a code is granted for identifying each site uniquely. Each code corresponds to each description of interface information of each piece of network equipment 211, 213 and 215.

The network management system 220 polls the MIBs periodically to collect the interface information for each piece of the equipment, compares the collected information with the registered one on the basis of code information, then corrects and manages the registered interface information automatically.

The user interface 230 queries the interface information of predetermined sites to the network management system 220 and displays the queries and answers.

Here, the network management system 220 comprises polling agents 221, 222 and 223 that polls each MIB periodically or at a time to get the interface information of each piece of the equipment, an automatic management module 224 that makes the information collected by the polling agents 221, 222 and 223 into a table and comparing the table with the already registered information to correct and manage the interface information automatically, and a database server 225 that interfaces with the user interface 230 and stores each kind of list and registration information for each piece of the equipment and each interface.

The operation of the network interface management system according to the present invention will be described below in detail.

As shown in FIG. 6, the network equipment system 210 includes a plurality of pieces of the network equipment 211, 213 and 215. Each piece of the equipment 211, 213 and 215 comprises a plurality of modules M11˜M13, M14˜M16 and M17˜M19 and one or more of MIBs 212, 214 and 216. The plurality of modules M11˜M19 comprise the predetermined number of ports 1˜8 connected to predetermined sites.

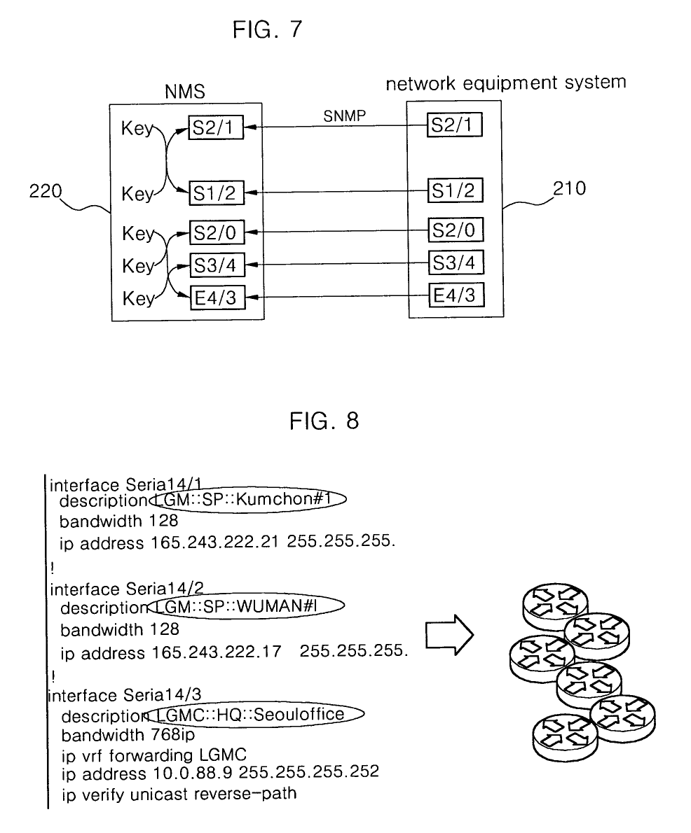

The MIBs 212, 214 and 216 contain the interface information for each piece of the equipment. The interface information includes equipment names (or host names), indexes of each module and interface according to connected sites. Additionally, as shown in FIG. 8, bandwidths for line speed, IP addresses and codes for identifying predetermined sites connected to each interface are also included in the interface information.

Each piece of the network equipment comprises a description item for each interface. A user can input descriptions to the description item. Corresponding description is registered to a standard MIB or an individual MIB for each company, so that corresponding value may be queried to the corresponding piece of equipment externally through the SNMP.

Each piece of the network equipment also grants a unique code to a predetermined site connected to a port to input the same to the interface description item. By using the code, the site can be identified. In order to input the code, corresponding interface of each piece of the equipment is selected and then a code including characters or symbols for identifying a site is input to the interface description item.

In addition, a bandwidth corresponding to the interface is also input, so that management can be performed automatically when the line speed changes

The code is classified and granted for each company, area or business department according to regulated rules and systemized as a tree structure. Accordingly, each code has a form of unique multi-step sub-code combination.

Each code is managed by using a DB table, DNS, X.500, or Lightwieght Directory Access Protocol (LDAP), etc. Here, a target connected to the interface may be a site name. Namely, each code is classified by using a classifier, LDAP, or X.500 etc.

If, for example, a target connected to the corresponding interface is “New Jersey branch office among foreign branch offices of ABC company”, a code can be implemented as follows using a 4 step tree system

Company code: ABC_INTN

Business code #1: EXPORT

Business code #2: BRANCH

Site Full Name: New Jersey Branch Office

The above tree structure, the sub-codes and classifiers are made into a single line code as follows. Here, the classifier is ‘::’, as an embodiment. For example, a code for New Jersey branch office among foreign branch offices of ABC company is implemented as ‘ABC_INTN::EXPORT::BRANCH::New Jersey Branch Office’.

According to the above method, a unique code, matching with each site connected to the interface of each piece of equipment as one-to-one, is input to the description item to be registered. Here, the code includes at least 2-step sub-code combination.

As an embodiment, the corresponding code may be granted as follows by using an address system comprising ‘.’, delimiter or a DN value in order to be queried by using X.500, LDAP or a Domain Name Server (DNS).

For example, the code may be implemented as NewjerseyBranchOffice.export.branch.abc_intn.

The interface code granting method for the network equipment management is now described. The code is input in order of company, area and business, etc., in order to identify a predetermined site using two colons ‘::’ as a classifier and comprised of at least 2-step sub-code combination.

For the convenience of description, the code may be comprised of 3 sub-codes combined into one line as the following order.

First, the company code, for example., LGCNS, uses a pre-defined code for each company and the business classifying code, for example, HQ, uses a pre-defined code for business property of sales, or a salesroom, etc. Here, the company code and business classifying code are input without any blank between characters.

A full name of the site is input within 50 characters in a free style. Here, special characters, for example, single/double quotation mark or ‘&’ cannot be used because they can make a problem in generating a SQL sentence. The code can be inputted exemplary as follows: LGCNS::HQ::Twin 10F Office.

Every piece of equipment has each different hostname, for example., DNIC7513C and the code should be always inputted uniquely within a single piece of equipment. However, the same codes are allowed between each different piece of equipment.

If each different piece of equipment has the same hostname, each code should be input uniquely. Namely, when each piece of equipment has different hostname each other, the granted codes may be the same. When any two or more pieces of equipment have the same hostname, however, the granted codes should be different each other.

Since a primary key value for being compared with the information registered to the network management system includes at least one hostname and code, so that the same hostnames and codes do not satisfy a condition for the primary key.

The uniqueness can be maintained by numbering as follows, when dual lines are connected to a single piece of equipment and a single site.

LGCNS::HQ::Twin 10F Office #1

LGCNS:: HQ:: Twin 10F Office #2

Alternatively, the codes may be granted each differently. That is, when 2 or more lines are connected to a single piece of equipment and a single site, the codes may be granted each differently or some information can be added to each code.

The interface code, which does not need automatic management or cannot be a comparison target, is stored to an exception list and excluded from the comparison targets in automatic management. Namely, when fields of company code and business calssifying code are any one among BAD for bad port, Test for test, Excp for exception, and RSVD for reserved, they are not compared, are skipped and written to a company code file, for example, except_cu.txt, and a business classifying code file, for example, except site.txt in the exception list. Additional exception lists are added to each corresponding file.

If a portion of interface names among information of pieces of the equipment collected through the SNMP have no need automatic management or should not be managed automatically, they are excluded from the comparison targets. For example, the should-be excluded interface name includes Null, loopback, ATM subif, VLAN, 0.0-AAL5 layer, 0-ATM layer, 0-AAL5 layer, EOBC0/0, unrouted VLAN and Multilink etc. The above exception lists are written in the exception list file. Additional interfaces to be excluded may be added to the corresponding files.

If a code value granted to a predetermined target for identification has sufficient readability, namely, in case that the network management system is for operation of the company's own, the code may be used as a site name

Since meanings of each sub-code of a code are already managed as a table, the information of a company or a department, etc., is inputted automatically. If meaning of a code value is sufficiently understood, a NMS for the company's own operation does not match a full name of the company or the department with the code value and can adopt the full name as a site name.

The network management system 220 comprises polling agents 221, 222 and 223, an automatic management module 224 and a database server 225. The polling agents 221, 222 and 223 read information periodically or in real time from the MIBs 212, 214 and 216. The automatic management module 224 reads the interface information for each piece of equipment periodically or in real time, depending on whether the equipment is an automatic management target. Then the automatic management module 224 manages the registered interface information automatically on the basis of the codes. The database server 225 is a database for storing the registration information and the collected table for each piece of equipment.

The network management system 220 registers the interfaces and codes for each piece of equipment to the database server 225 as shown in FIG. 8 in order to manage each piece of the interface information registered to the MIBs 212, 214 and 216.

More specifically, the interface information for each piece of the equipment in the network management system 220 includes equipment names, indexes, bandwidths, interface information and a unique code for a connection target. Here, the unique code is inputted identically with the one registered to any one of the MIBs 211, 213 and 215.

After reading all of the interface information for each piece of the equipment, the network management system 220 selects targets to be managed and registers a list of the targets to the database server 225.

That is, the network management system 220 reads the codes inputted to the description items from each piece of the equipment through the SNMP and registers them. Here, NMS for customers is also applied to a Maintenance Service Provider (MSP).

In order to manage the network automatically, the automatic management module 224 of the network management system 220 accesses the MIBs 212, 214 and 216 to request the interface information of each piece of the equipment, which are indicated in the list of management target equipment registered previously to the database server 225, periodically, at a time or in real-time using the polling agents 221, 222 and 223, and reads the interface information for each piece of the equipment with the codes of the connection targets.

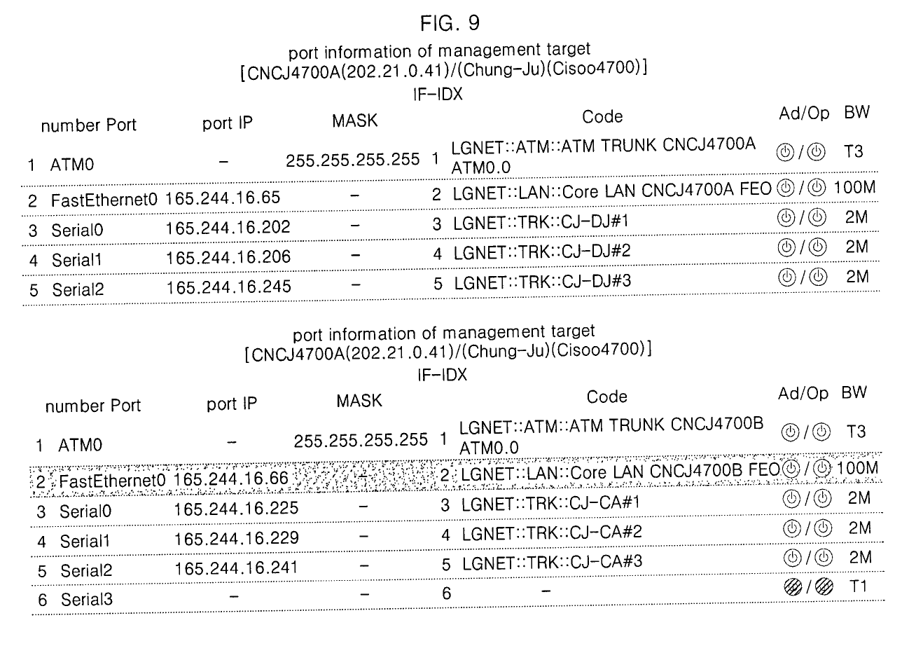

The automatic management module 224 makes a table as shown in FIG. 9 using the interface information collected from the MIBs 212, 214 and 216 by the polling agents 221, 222 and 223. Namely, the automatic management module 224 makes the table for each piece of the equipment/interface after collecting all of the information of each piece of the equipment including host names, interface names, operation statuses, codes, etc., which is registered to the automatic management equipment list through the SNMP.

At this time, the automatic management module 224 checks code repetition or non-defectiveness, etc., of the collected interface information to prevent unnecessary management.

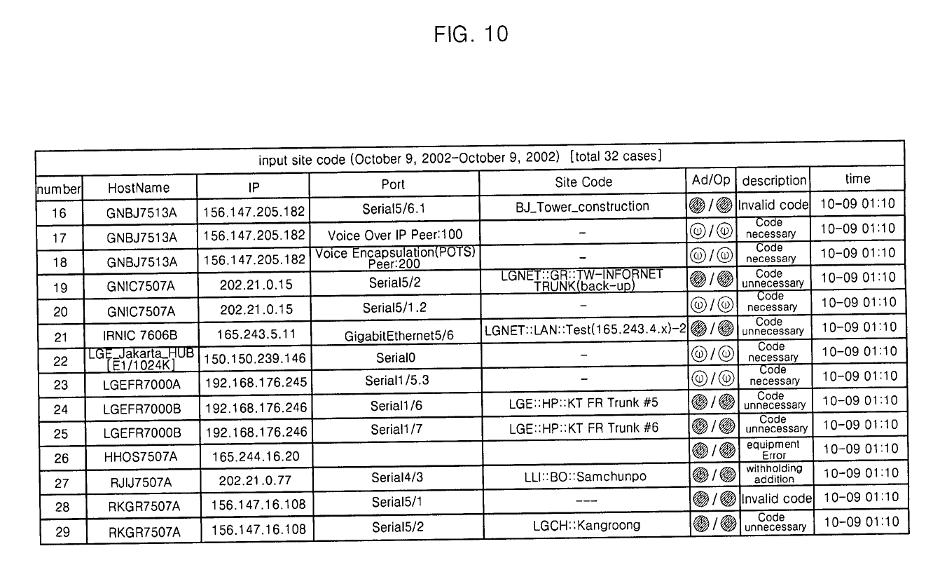

As shown in FIG. 10, the uniquely granted code value becomes the primary key. Therefore, the code value should not be repeated and be checked if it is necessary and written exactly. Then, the check results are informed to the administrator.

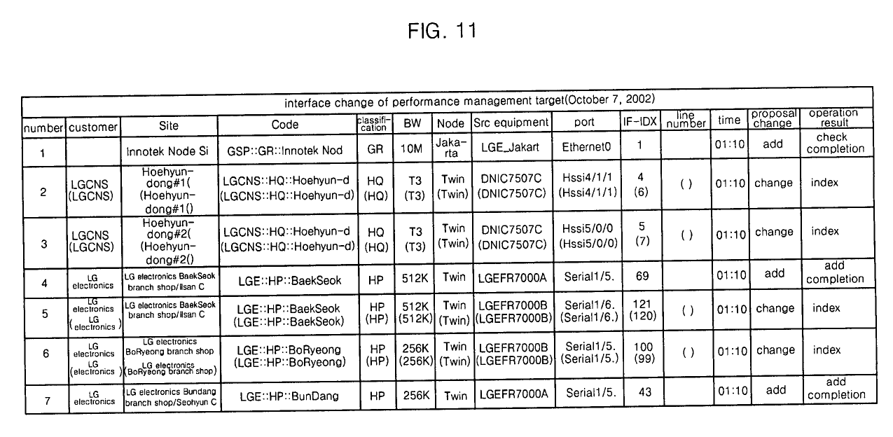

After the non-defectiveness check, as shown in FIG. 11, the automatic management module 224 compares all of equipment names and codes included in the interface information collected from each piece of the automatic management target equipment with the ones previously registered to the database server 225 to find the same equipment names and codes. Then, the automatic management module 224 checks if there is any change in the interface information and corrects the interface information on the basis of the changed codes automatically.

More specifically, when there are module adds/replacements/drops or port adds/changes in a predetermined piece of equipment, the equipment name and unique code of the corresponding equipment are adopted as the primary key to be compared with the information registered to the database server 225. Then, the same codes are found to replace the registered information with the corresponding one in the collected table.

As an embodiment, a single code can be adopted as the primary key in order to be compared with the interface information of the collected table. Then, the network management system can correct or update, the interface information automatically, when the lines are changed to connect with the other piece of equipment.

Accordingly, an interface status of a predetermined piece of equipment can be queried in a predetermined period or in the present time through the user interface 230 and the answers can also be confirmed exactly.

Referring FIG. 7, the network management system 220 adopts the code as the primary key to change the indexes of the registered interface information automatically on a basis of the code read form the network equipment system 210.

The network management method performed in the network management system will be described below in detail.

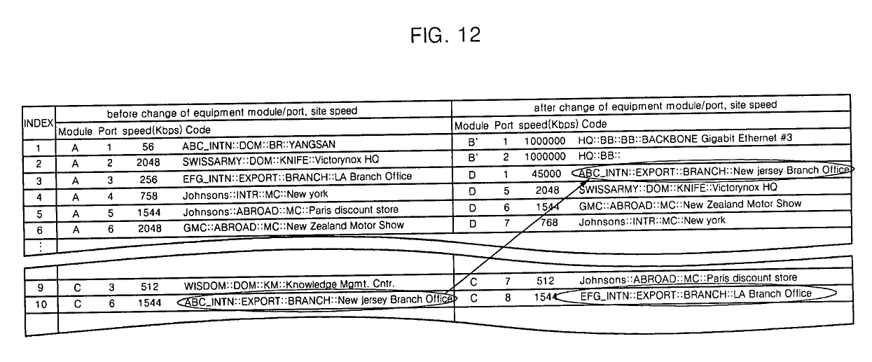

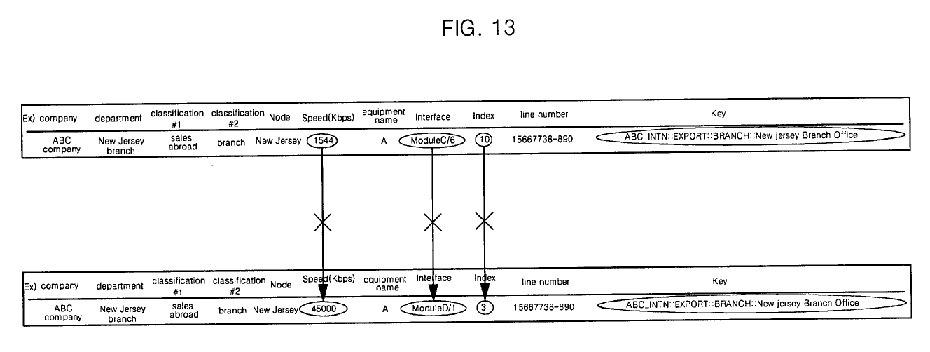

Referring to FIG. 12, when a piece of equipment A was registered to the network management system and then modules in the equipment are changed, there are many differences between a table collected from the MIBs of the equipment A by the automatic management module and the information registered to the database server.

As an example, before the module change, ABC company New Jersey branch office has an index of 10, a module of C and interface information including a port of 6, speed of 1544 and a code of ABC_INTN::EXPORT::BRANCH::New Jersey Branch Office. After the module change, the index becomes 3, the module becomes D and the interface information becomes changed to a port of 1, speed of 4500 and a code of ABC_INTN::EXPORT::BRANCH::New Jersey Branch Office.

If data is read on the basis of the previous indexes as registered to the network management system without change of the information after the module change, the read results become wrong. If, for example, an index 10 of the equipment A is read in order to get utilities of ABC company New Jersey branch office after the module change, the one of EFG company LA branch is queried.

To solve this problem, the automatic management module compares the collected table and the previously registered information, finds the same equipment and code and then replaces the interface information before the module change with the one after the module change on the basis of the same equipment and code.

Then, the index is changed from 10 to 3, the interface is changed from a module C/6 to D/1 and the speed is also changed from 1544 to 45000 automatically.

As an embodiment, the automatic management module comprises a change management system separately from the network management system. Whenever a configuration of the equipment is changed, the change management system informs the change to the network management system periodically or in real-time. Alternatively, the change management system reads all of values in the MIBs of the corresponding equipment using system log, namely Syslog, transmitted from the equipment to the network management system periodically or in real-time. The network management system reads the interface information of the corresponding equipment and adopts a code as the primary key to correct the changes automatically.

The interface information may be changed automatically with restriction to the predetermined changed pieces of equipment, not including all of the pieces of the equipment.

The operation of the automatic management module will be described in detail with references of FIG. 6 and FIG. 14 through FIG. 18.

The automatic management module 224 comprises a management target equipment list portion 234, a site code management portion 244, an automatic management engine 254, an interface management display 264.

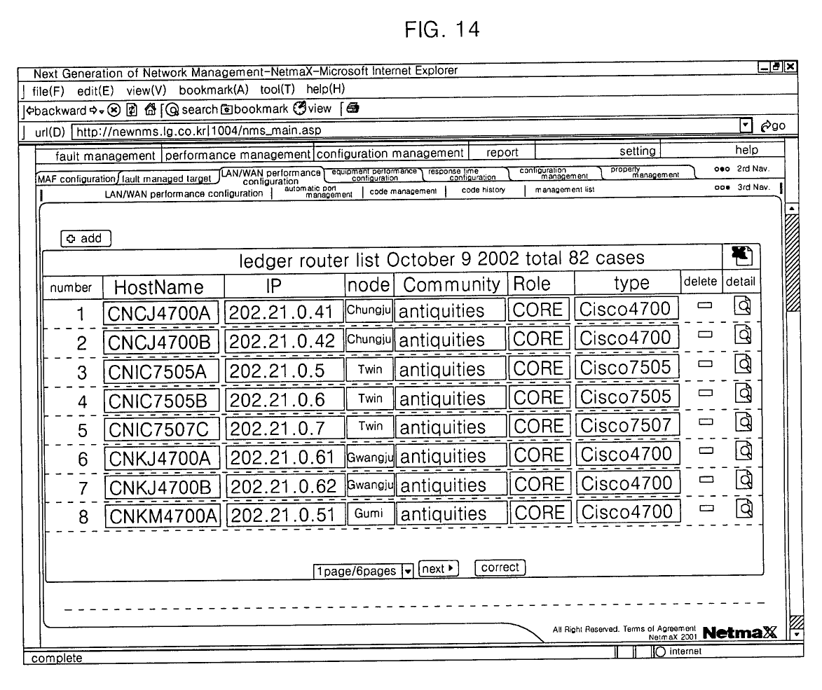

As shown in FIG. 14, the management target equipment list portion 234 manages a list of pieces of equipment whose interface changes are to be managed. While the equipment list is registered already to the network management system, host names becoming a portion of the key values for comparing the currently collected interface information with the registered one, IP addresses, communication strings for querying to the corresponding equipment through the SNMP, and other necessary information are inputted together to the equipment list and managed.

The management target equipment list portion 234 also decides if each piece of equipment needs automatic management according to its characteristics or a version of operation system, etc., and registers corresponding equipment to the list, if necessary. Then, the management target equipment list portion 234 reads the information of all or a portion of pieces of equipment periodically or at any time using the list and makes a table for comparing the read information with the registration one in the network management system.

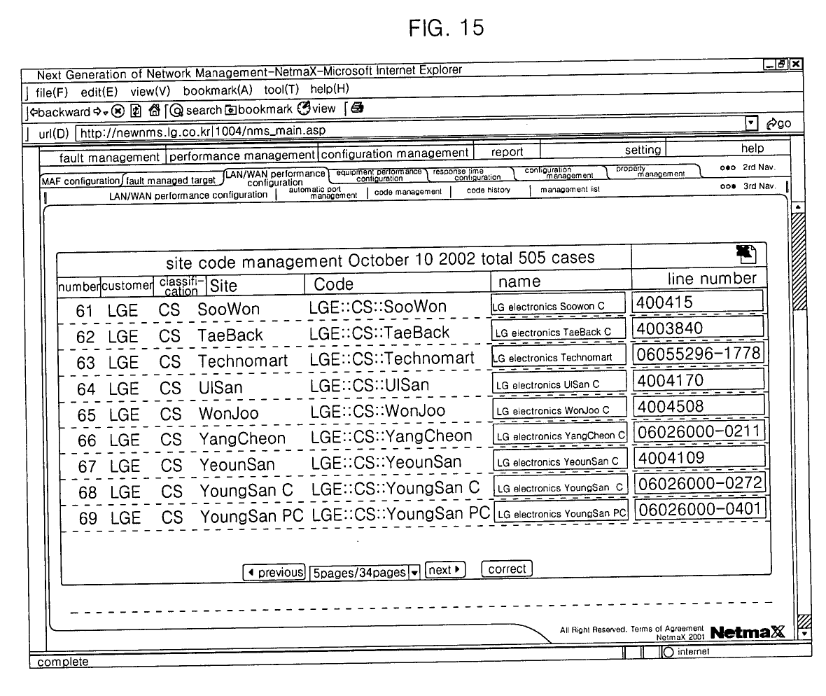

The site code management system 244, as shown in FIG. 15, is inputted a name and line number corresponding to each code for user's convenience to enable them to be displayed within the network management system.

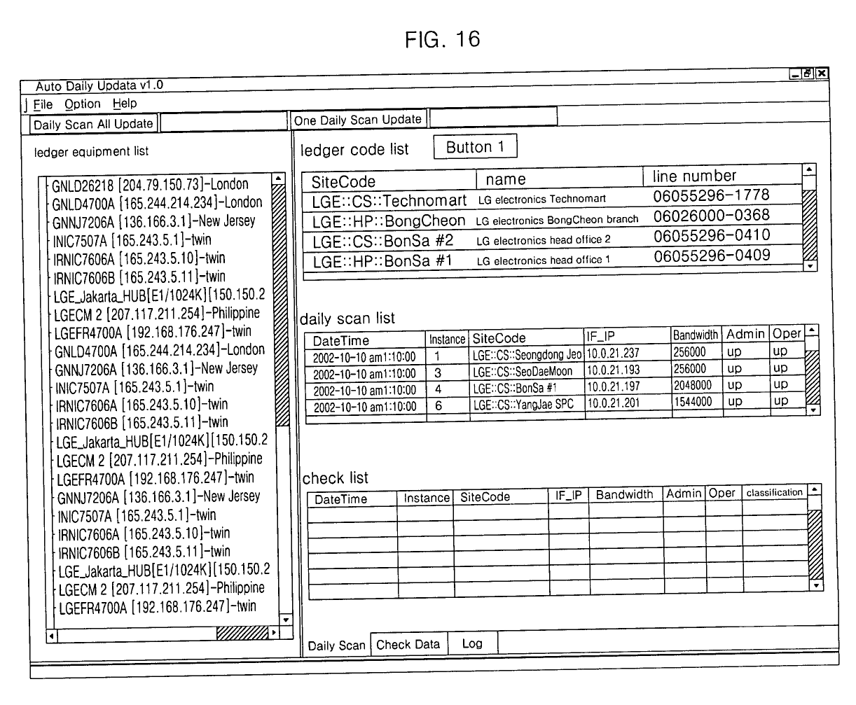

The automatic management engine 254, an application for performing general automatic management as shown in FIG. 16, is operated inside the automatic management module. It collects current equipment information periodically or in real-time using the automatic management target list and compares the collected information with the one registered to the network management system. If the collected information is changed or of a new interface, the changed or new interface information is added to the automatic management target list. The information of the dropped interfaces is deleted from the automatic management target list.

The automatic management engine 254 collects information all/a part of pieces of equipment periodically/at any time to table it, checks uniqueness and non-defectiveness of the interface information in the table and deletes a code from the table, if the code is not unique or defective.

It also generates a log of a code that is not valid, used or added, and deletes the corresponding code from the table. It generates another log for an exceptional code existing in a predetermined exception list and deletes the interface information corresponding to the exceptional code from the table. It also checks whether a code is necessary by checking the operation state of each piece of the equipment and generate a corresponding log.

It also compares the current collected table information with the one registered to the database server of the network management system. If an interface is newly added, the corresponding information is added to the information registered to the database server automatically. If an interface is deleted, it is deleted from the information registered to the database server automatically

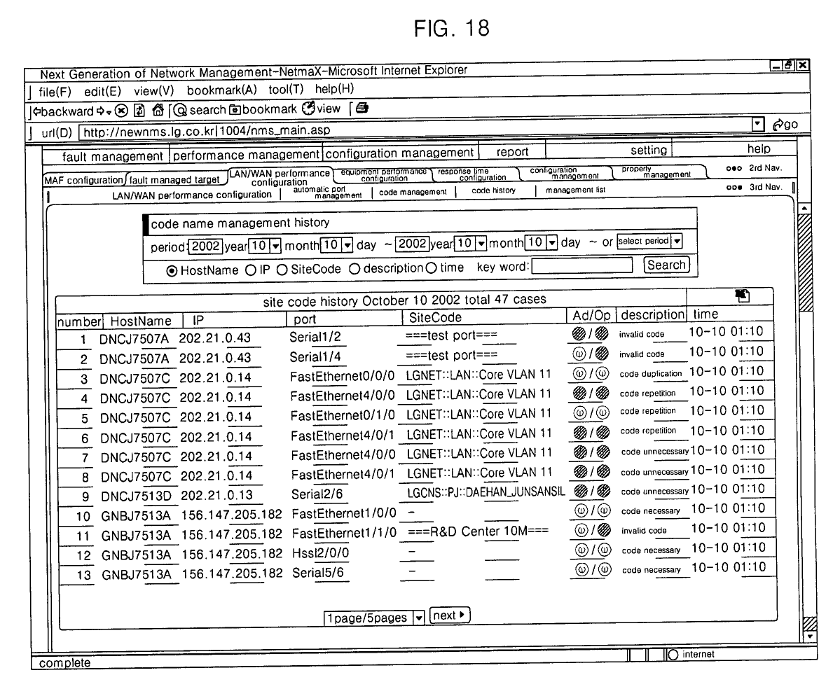

When an interface is added or deleted, the automatic correction log and a list of functions in need of the administrator's intervention are generated. The unnecessary site names and line information are cleared off. Here, the log is generated after executing the automatic management engine. As shown in FIG. 18, the log is notified to the administrator for exact automatic management by checking abnormality or rule violation for the equipment.

The log is generated when rules for code grant are violated, the same codes are existed in a piece of equipment, a code exists but an unused interface or operation state is down/down, a code is not granted but a used interface or operation state is up/up, a new code is added, the automatic management engine clears site codes off, and the codes are included in a list of the deleted codes that are no linger used in the network management system. The generated log is notified to the administrator.

A log denotes invalid when the interface information is not valid, code repetition when the same codes exist in a piece of equipment, unnecessary when the code is not used and necessary when the interface is added.

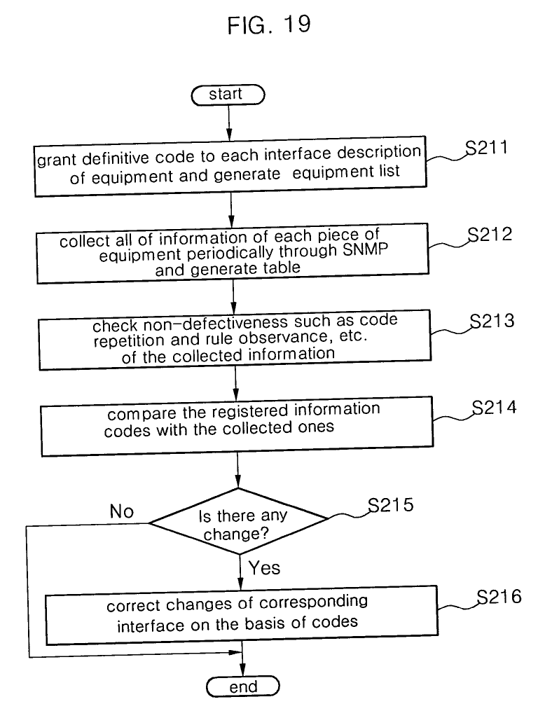

FIG. 19 illustrates a flow chart of a method for managing network interface information automatically according to the present invention.

Referring FIG. 19, the network management system grants a definitive code to each description of the interface information of each piece of the equipment and generates an equipment list (step S211).

The network management system collects MIB values from all of the information for each piece of equipment through the SNMP periodically or in real-time and makes a table (step S212). Then, it checks non-defectiveness such as code repetition and rule observance, etc., of the collected information (step S213).

The network management system compares codes of the information registered to itself with the ones of the collected information (step S214) and finds any change (step S215).

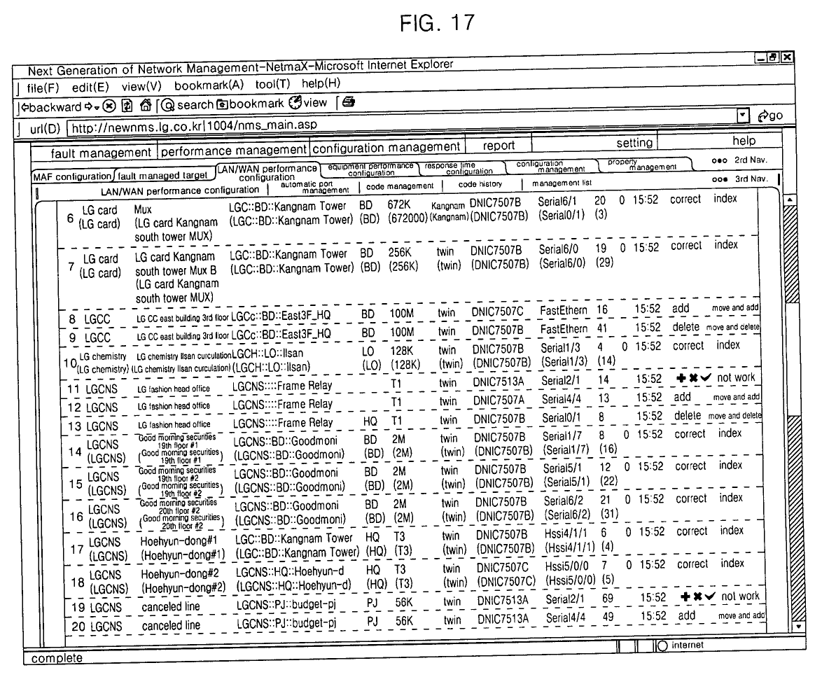

If there is any change, the corresponding change is corrected automatically (step S216). The automatically corrected interface information is displayed as FIG. 17.

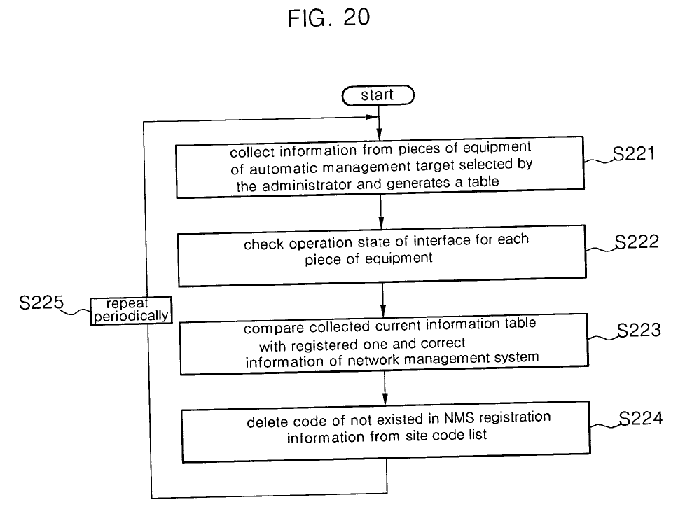

The operation of the automatic management engine will be described below with reference to FIG. 20.

The automatic management engine collects information from pieces of automatic management target equipment selected by the administrator and generates a table (step S221).

When a code of the collected information is not unique or a predefined exceptional one that does not observe rules in generation of the table, the code is deleted from the table and the corresponding log is generated in order not to be compared with the one in the information registered to the network management system.

These exceptional codes are caused by tentative test or drop of a meaningless virtual interface. A part of the interfaces do not need the automatic management or should not be managed automatically.

The automatic management engine checks an operation status of an interface for each piece of equipment (step S222) to leave a log in order for the administrator to delete codes if the interfaces are not in use. When the operation statuses are normal, namely, up/up but the codes are not written, the corresponding interfaces should be managed. Therefore, the automatic management engine leaves a log in order for the administrator to input the codes to each piece of the equipment.

Then, the automatic management engine compares the collected current information table (information of current equipment) with the one registered already to the network management system (original table) and corrects the registered one (step S223).

When correcting the information of the network equipment in step S223, the automatic management engine compares each code for each piece of the equipment with each other and corrects indexes, bandwidths, names and line numbers, etc., automatically, if there is any change.

If a code, not having been existed in the original table of a predetermined piece of equipment, exists in a current information table, it is considered as an additional line, namely a used or added interface, and listed up to an additional target list with a host name.

If a code, having been existed in the original table of a predetermined piece of equipment, does not exist in a current information table, it is for a canceled line, namely disused or deleted interface, or it is for a line moved to the other equipment. Then it is first retrieved from the additional target list. If it is not on the additional target list, the automatic management engine notifies the absence to a cancellation target line in order for the administrator to delete it (step S224).

If there is a single code is in the additional target list, the corresponding line is considered as moved. Therefore, the automatic management engine 254 moves all of the information of the corresponding line remained in the network management system to a piece of equipment to which the interface is added and leaves a log.

If there are two or more codes in the additional target list, the automatic management engine notifies all of the information to the administrator so that the administrator can decide to move, add or delete the codes.

After information correction, the automatic management engine 254 repeats the above steps with respect to codes of not being existed in the network management system, namely codes of canceled lines or disused interfaces, on the basis of a site code list (step S225).

After the automatic management engine 254 is executed, the automatic interface management display 264 displays a web page as shown in FIG. 17 for enabling manual operations by a single click on the web page, if a log of the automatically corrected information and intervention of the administrator are needed.

If necessary, the administrator may add/move/delete corresponding lines, namely interfaces, directly.

While the invention has been shown and described with reference to certain preferred embodiments thereof, it will be understood by those skilled in the art that various changes in form and details may be made therein without departing from the spirit and scope of the invention as defined by the appended claims. The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

I claim:

1. An apparatus for managing network interface information, comprising:
a network equipment system having information that can identify a site connected to one or more interfaces of each piece of network equipment and including one or more management information bases that store the interface information; and
a network management system for polling the management information bases of each piece of the network equipment within the network equipment system to collect the interface information, adopting information that can identify each site as primary information to compare the primary information with already registered information and correcting the interface information for each piece of the network equipment.

2. The apparatus according to claim 1, wherein the information is identification one that can identify a predetermined site, which is connected to the interface of one or more pieces of the equipment.

3. The apparatus according to claim 2, wherein the identification information is a code or identification characters, and each code is granted according to pre-defined rules in order to identify a predetermined site by steps and comprised of multi-step sub-codes.

4. The apparatus according to claim 3, wherein the multi-step sub-codes comprise classifiers in order to classify each code.

5. The apparatus according to claim 4, wherein each code is classified by using at least one of a group of classifier, a Lightwieght Directory Access Protocol and X.500.

6. The apparatus according to claim 3, wherein each code corresponds to each interface description of each piece of the network equipment.

7. The apparatus according to claim 6, wherein each code is inputted to an interface description of each piece of the network equipment.

8. The apparatus according to claim 1, wherein the network management system reads a code inputted to an interface description of each piece of the network equipment through Simple Network Management Protocol and registers the read code to a list of each piece of automatic management target equipment, when registering the interface of the corresponding network equipment.

9. The apparatus according to claim 1, wherein the network management system reads interface information of each piece of automatic management target equipment, adopts at least one of the codes and host names as primary information, compares the primary information with the already registered information and corrects any change if there is, at every predetermined time or in real-time.

10. An apparatus for managing network interface information automatically, comprising:
polling agents for polling interface information of each piece of network equipment from management information bases of each piece of the network equipment at every predetermined time or in real-time;
an automatic management module for confirming changes or adds of the interface information read from the polling agents, correcting or managing the interface information; and
a database server for storing registration information for each piece of the network equipment or each interface managed by the automatic management module and providing user interface with the stored information.

11. The apparatus according to claim 10, the automatic management module comprising:
a management target equipment list portion for managing interface changes;
a site code management portion for enabling information matched with each code to be inputted and displayed;
an automatic management engine for collecting information of each piece of the network equipment at every predetermined time or in real-time using the management target list and comparing the collected information with the registration information to manage network interface information automatically; and
an interface management display portion for displaying a log of corrected information and intervention by an administrator, if necessary, as a web page.

12. A method for managing network interface information, comprising steps of:
(a) granting codes, indicating sites connected to each interface of each piece of network equipment and generating a management target equipment list;
(b) collecting interface information for each piece of the network equipment through Simple Network Management Protocol to generate a table at every predetermined time or in real-time;
(c) checking non-defectiveness of the codes for the collected interface information of the table; and
(d) comparing information registered to a network management system with the collected table using the granted codes and correcting changes of the registered information.

13. The method according to claim 12, the automatic management for the network equipment comprising the sub-steps of:
collecting information from each piece of the automatic management target equipment selected by an administrator to generate the table;
notifying abnormal codes among the collected information to the administrator, deleting the abnormal codes from the collected table, checking operation statuses of an interface of each piece of the network equipment to decide if the codes are necessary and notifying the checked results to the administrator;
comparing the collected table with the registered information and correcting the registered information; and
deciding if a line is canceled or used and deleting unregistered codes from a site code list.

14. A method for managing network interface information, comprising the steps of:
(a) inputting interface information connected or to be connected to an interface of each piece of network equipment;
(b) matching the interface information with interface description;
(c) registering the inputted information to a network management system; and
(d) changing the interface information using codes of the inputted or registered information.

15. The method according to claim 14, wherein interface information such as Null or loop-back, of no meaning in automatic management is not used as information for change.

16. The method according to claim 14, wherein each piece of the network equipment has different hostname each other.

17. The method according to claim 16, wherein granted codes may be the same if each piece of the network equipment has different hostname each other.

18. The method according to claim 14, wherein granted codes are different each other if there are any two or more pieces of the network equipment having the same hostname.

19. The method according to claim 14, wherein code information is granted differently each other or predetermined information is added to a code, which is granted to a site, if there are 2 or more lines at a site of the same interface or the same piece of the network equipment.

20. A method for managing network interface information, comprising the steps of:
(a) inputting a hostname to each piece of network equipment;
(b) inputting interface information including a code of corresponding site to one or more interfaces of each piece of the network equipment;
(c) generating an automatic management list to register the list to a network management system;
(d) receiving current network equipment information at a predetermined period or in real-time, comparing the received information with the one registered to the network management system using one or more hostname and code information, and performing at lest one of a group of change of the interface information, addition of a new interface and deletion; and
(e) displaying a new interface management picture.

21. The method according to claim 20, further comprising reading management information base values of a corresponding piece of network equipment using SYSlog transmitted from each piece of the network equipment at a predetermined time or in real-time, if interface information is changed.
